(19) United States
(12) Patent Application Publication
(10) Pub. No.: US 2025/0214161 A1
(43) Pub. Date: Jul. 3, 2025

(54) PNEUMATIC SAW

(71) Applicant: DIN LONG INDUSTRIAL CO., LTD., Taoyuan (TW)

(72) Inventor: Jung-Fu HSIEH, Taoyuan (TW)

(21) Appl. No.: 18/402,212

(22) Filed: Jan. 2, 2024

(51) Int. Cl. B23D 51/18

(52) U.S. Cl. CPC B23D 51/18

(57) ABSTRACT

A pneumatic saw includes a housing, a piston casing, a piston, and an air guide assembly. The air guide assembly is in the housing, and includes a reversing brake block, an air guide base, a spacer plate on the air guide base, and an air blocking ring on the air guide base. The air guide base includes an air inlet duct for accommodating the reversing brake block, and primary working air ducts communicated with the air inlet duct, and secondary working air ducts communicated with the air inlet duct. The primary and secondary working air ducts respectively includes a longitudinal hole parallel to the air inlet duct, and a transverse through hole communicated with the air inlet duct and the longitudinal hole. The transverse through hole is shielded by the air blocking ring, and the air blocking ring is fixed to the air guide base by a pin member.

### FIELD OF THE INVENTION

The present invention relates to a pneumatic saw.

### BACKGROUND OF THE INVENTION

A pneumatic saw achieves the purpose of reciprocating a saw blade by means of a reversing module. TWI428212 discloses a cylinder and reversing functional module structure of a reciprocating pneumatic tool, wherein the cylinder and reversing functional module structure includes an air pressure introducing seat (in this case, reference numeral 30), and a positive air inlet guide hole (in this case, reference numeral 33), a reversing action groove (in this case, reference numeral 40) communicated with the positive air inlet guide hole, two secondary air inlet guide holes (in this case, reference numeral 36) communicated with the positive air inlet guide hole, and two oblique perforations (in this case, reference numeral 42) communicated with the reversing action groove are formed in the air pressure introducing seat. The secondary air inlet guide holes and the oblique perforations are formed in an oblique direction, so that it is relatively difficult to manufacture the air pressure introducing seat as the air pressure introducing seat can be accurately formed by precise alignment during manufacturing.

In another aspect, the conventional pneumatic saw further includes an air inlet seat for providing an air valve, and the air inlet seat is matched with a front section of the air pressure introducing seat. The conventional pneumatic saw has two sets of connecting grooves provided in a housing at locations where the air inlet seat is expected to be provided, and the two sets of connecting grooves is sued for providing two annular members for locating the air inlet seat therein. Although the two annular members can stably limit the position of the air inlet seat, the air inlet seat is difficult to disassemble, thus resulting in the problem that the pneumatic saw is not repairable or difficult to repair.

### SUMMARY OF THE INVENTION

A primary object of the present invention is to solve the problem that a diversion casing for reversing of a conventional pneumatic saw is difficult to manufacture.

A secondary object of the present invention is to solve the problem deriving from the limiting means for the air inlet casing of the conventional pneumatic saw for subsequent repair.

In order to achieve the above objects, the present invention provides a pneumatic saw provided for s a saw blade reciprocating upon activation. The pneumatic saw includes a housing including a hollow shape, a piston casing provided in the housing, a piston provided on the piston casing and used for pushing the saw blade, and an air guide assembly provided in the housing. The piston casing is formed with a piston working space for providing the piston therein, and a plurality of return ducts communicated with the piston working space. The air guide assembly includes a reversing brake block, an air guide base, a spacer plate provided on a side of the air guide base facing the piston casing, and an air blocking ring provided on the air guide base. The air guide base includes an air inlet duct provided for disposal of the reversing brake block therein and communicating with the piston working space, a plurality of primary working air ducts communicating with the air inlet duct, and a plurality of secondary working air ducts communicating with the air inlet duct and the return ducts. Each of the primary working air ducts and each of the secondary working air ducts respectively include a longitudinal hole parallel to the air inlet duct, and a transverse through hole communicating with the air inlet duct and the longitudinal hole, and one end of the transverse through hole is shielded by the air blocking ring. The air blocking ring is fixed to the air guide base by a pin member, and the air guide base includes a pin mounting hole for providing the pin member.

In one embodiment, the plurality of transverse through holes of the primary working air ducts are located on a same extension line, and two of the plurality of transverse through holes of the secondary working air ducts are located on a same extension line.

In one embodiment, two of the plurality of transverse through holes of the secondary working air ducts are provided side by side.

In one example, the air guide base includes a vent groove communicated with the primary working air ducts and the air inlet duct.

In one embodiment, the air guide base includes an air leakage hole connected to the air inlet duct, and the air leakage hole is not shielded by the air blocking ring.

In one example, the air guide base includes a plurality of first connecting holes, the piston casing includes a plurality of second connecting holes respectively connected to the first connecting holes, each of the first connecting holes is respectively provided for disposal of a connecting member therein, and the connecting member includes a cap portion capable of limiting a position of the air blocking ring.

In one embodiment, the pneumatic saw includes an air inlet assembly matched with the air guide assembly, the air inlet assembly includes an air inlet seat provided in the housing, an air valve provided in the air inlet casing, and an operating rod provided on the air inlet casing and connectable to the air valve, the housing includes a through hole through which the operating rod passes, the air inlet casing includes an air inlet passage communicating with the air inlet duct of the air guide base, a mounting manifold communicating with the air inlet passage, and a rod mounting hole corresponding to the through hole and provided for insertion of the operating rod, the air valve is located at an intersection of the air inlet passage and the mounting manifold, an opening of the mounting manifold is assembled with a closure, and the air inlet casing and the housing are assembled in a threaded manner.

In one embodiment, the pneumatic saw includes an air exhaust space formed between the air inlet seat and the housing, at least one noise reduction member provided in the air exhaust space, at least one noise reduction member limiting plate provided on a side of the air inlet casing facing the air guide base to limit the at least one noise reduction member to be located at a periphery of the air inlet casing, and a spring respectively abuts against the noise reduction member limiting plate and the air guide base, and the noise reduction member limiting plate includes at least one via hole provided corresponding to the at least one noise reduction member.

According to the foregoing implementation of the present invention, the following features are provided compared with the conventional pneumatic saw: the primary working air ducts and the secondary working air ducts on the air guide base according to the present invention are all not implemented with oblique holes, thus reducing the difficulties in manufacturing and a reject ratio.

### BRIEF DESCRIPTION OF THE DRAWINGS

FIG. 1 is an exploded view of a structure of a pneumatic saw according to an example of the present invention.

FIG. 2 is an exploded view of the structure of the pneumatic saw in another direction according to an example of the present invention.

FIG. 3 is a schematic diagram (I) showing implementation of the pneumatic saw according to an example of the present invention.

FIG. 4 is a schematic diagram (II) showing implementation of the pneumatic saw according to an example of the present invention.

FIG. 5 is a schematic diagram (III) showing implementation of the pneumatic saw according to an example of the present invention.

FIG. 6 is a schematic diagram (IV) showing implementation of the pneumatic saw according to an example of the present invention.

FIG. 7 is a schematic diagram showing assembly of an operating rod of the pneumatic saw according to an example of the present invention.

### DETAILED DESCRIPTION OF THE PREFERRED EMBODIMENTS

The detailed description and technical contents of the present invention are now described with reference to the accompanying drawings as follows:

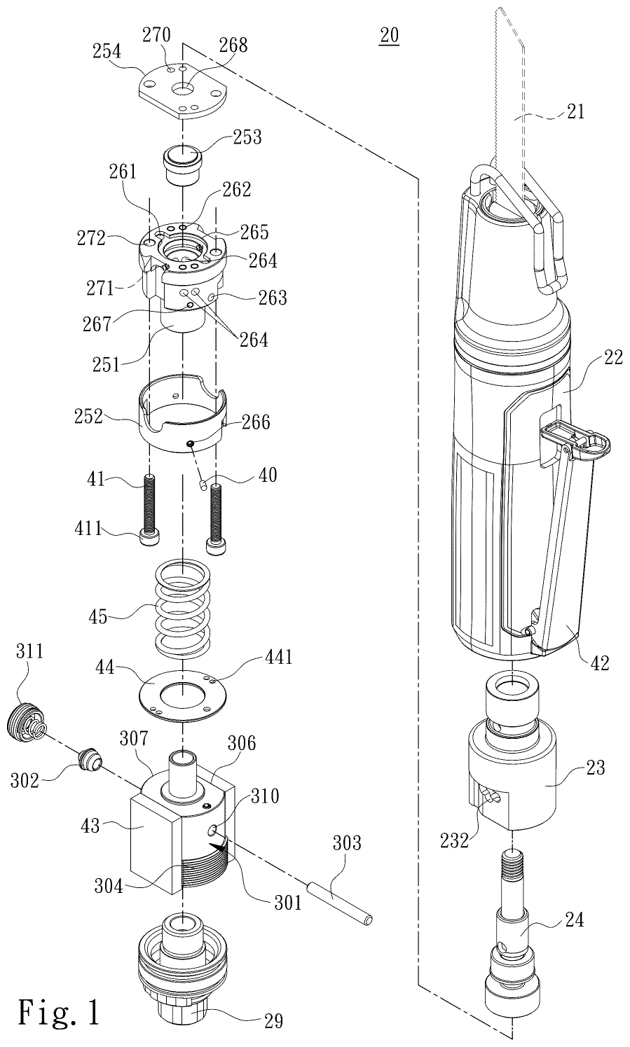

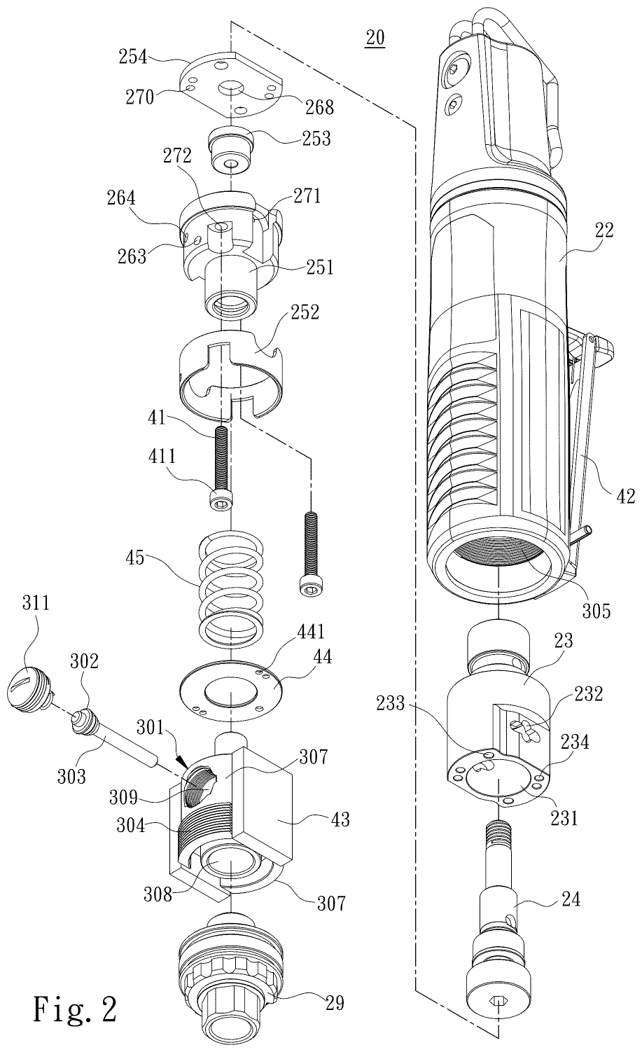

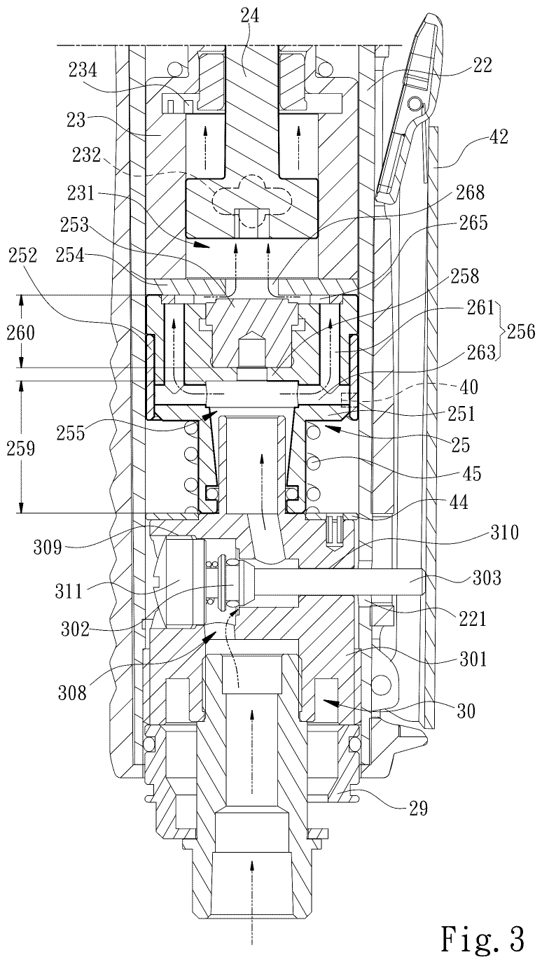

Referring to FIG. 1, FIG. 2, and FIG. 3, the present invention provides a pneumatic saw 20 provided for a saw blade 21 reciprocating upon activation. The pneumatic saw 20 includes a housing 22, a piston casing 23, a piston 24, and an air guide assembly 25, wherein the housing 22 includes a hollow shape, the piston casing 23 is provided in the housing 22, the piston casing 23 is formed with a piston working space 231, the piston 24 is provided in the piston working space 231, and the piston 24 is used for pushing the saw blade 21.

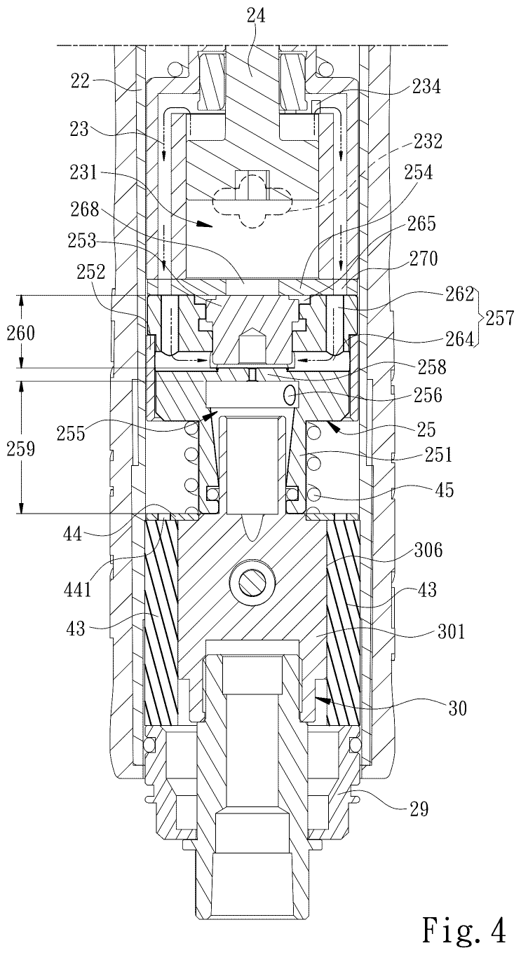

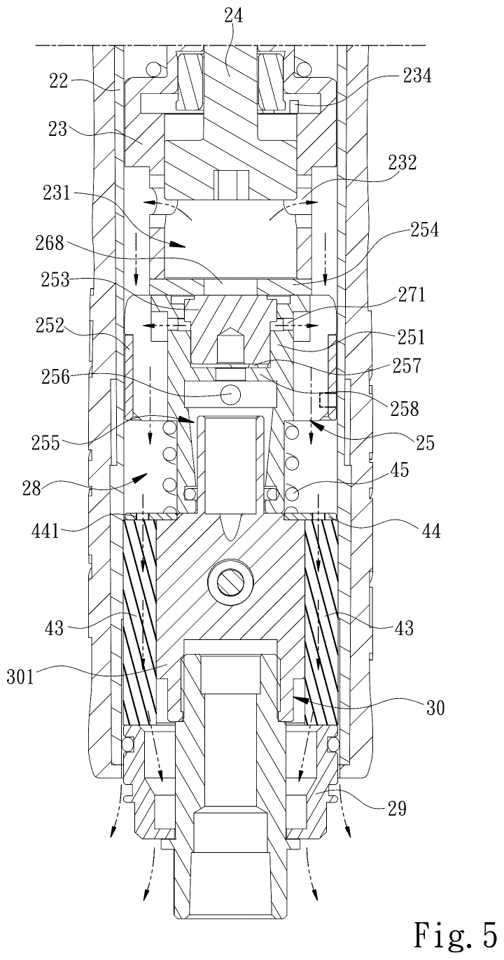

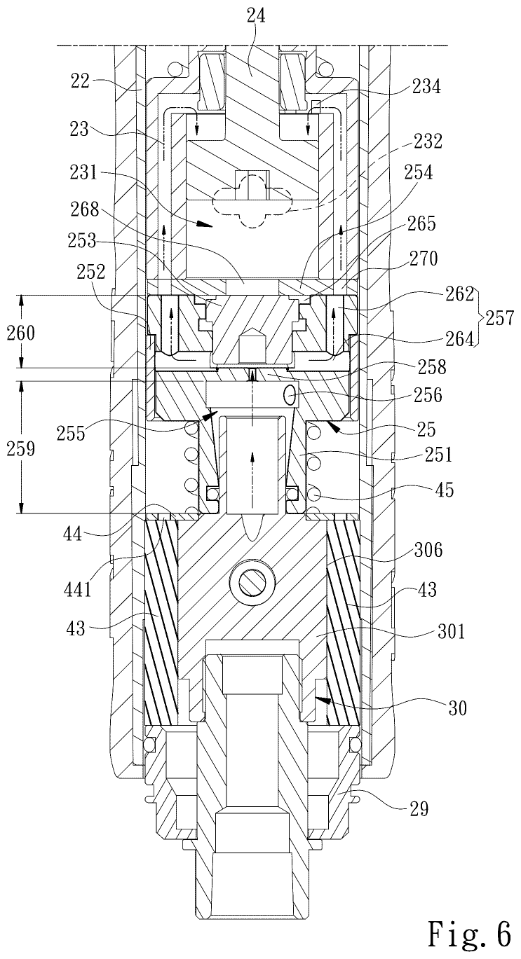

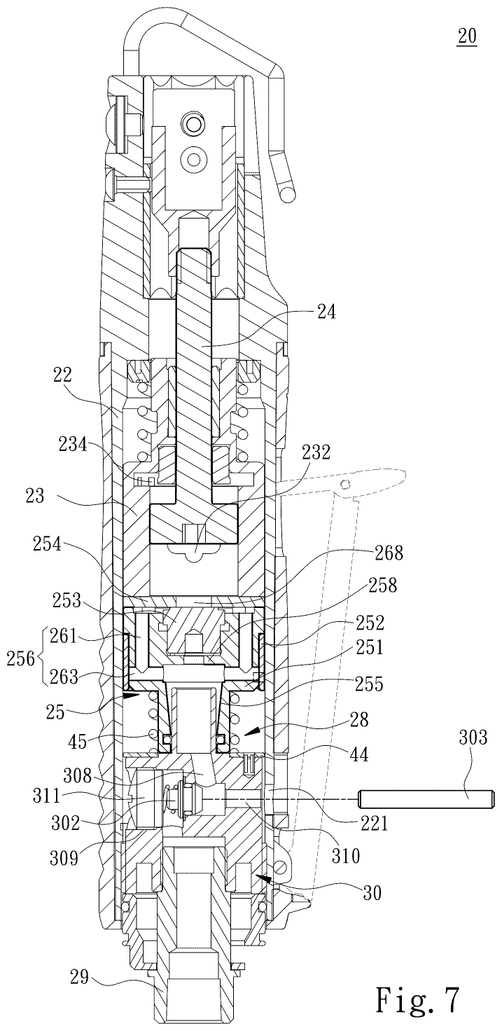

Referring also to FIG. 1, FIG. 2, FIG. 3, FIG. 4, FIG. 5, FIG. 6, and FIG. 7, the air guide assembly 25 is provided in the housing 22 and includes an air guide base 251, an air blocking ring 252, a reversing brake block 253, and a spacer plate 254. The air guide base 251 includes an air inlet duct 255, a plurality of primary working air ducts 256 communicating with the air inlet duct 255, and a plurality of secondary working air ducts 257 communicating with the air inlet duct 255. The air guide base 251 is formed with a partition rib 258 in the air inlet duct 255, the partition rib 258 divides the air inlet duct 255 into a first section 259 and a second section 260 communicating with the first section 259, and further, the partition rib 258 is an annular structure formed along an inner wall of the air inlet duct 255. Also, an opening in one end of each of the primary working air ducts 256 is communicated with the first section 259 of the air inlet duct 255, and an opening in other end of each of the primary working air ducts 256 is located on a surface on which the air guide base 251 is expected to be assembled with the spacer plate 254. On the other hand, an opening in one end of each of the secondary working air ducts 257 is communicated with the second section 260 of the air inlet duct 255 facing the reversing brake block 253, and an opening in the other end of each of the secondary working air ducts 257 is located on the surface on which the air guide base 251 is expected to be assembled with the spacer plate 254.

Referring back to FIG. 3 and FIG. 4, each of the primary working air ducts 256 and each of the secondary working air ducts 257 of the present invention respectively include a longitudinal hole 261 (262) parallel to the air inlet duct 255 and a transverse through hole 263 (264) communicated with the air inlet duct 255 and the longitudinal hole 261 (262). The longitudinal hole 261 (262) and the transverse through hole 263 (264) are respectively formed through a drilling operation, and the structure of the present invention can simplify a manufacturing process and reduce the occurrence of drilling errors without requiring oblique placement of a workpiece to be machined at a special angle during the drilling operation. Further, an opening in one end of the transverse through hole 263 (264) can be directly observed from an external appearance of the air guide base 251. On the other hand, the air guide base 251 includes a vent groove 265 communicated with the primary working air ducts 256 and the air inlet duct 255, the vent groove 265 is provided on a surface on which the air guide base 251 is expected to be assembled with the spacer plate 254, and an opening in one end of each of the primary working air ducts 256 is located in the vent groove 265.

Further, the air blocking ring 252 is sleeved on the air guide base 251 and shields one end of the transverse through hole 263 (264), namely, air is prevented from being exhausted therefrom. Furthermore, in order to prevent high-pressure air flowing in the transverse through hole 263 (264) from erroneously pushing the air blocking ring 252, the air blocking ring 252 is further fixed to the air guide base 251 by a pin member 40. Further, the air blocking ring 252 includes a perforation 266, and the air guide base 251 includes a pin mounting hole 267 facing the perforation 266 and provided for the pin member 40 to be disposed therein.

From the foregoing, the reversing brake block 253 is provided in the second section 260 of the air inlet duct 255, and the reversing brake block 253 is movable in the second section 260 of the air inlet duct 255. On the other hand, the spacer plate 254 is provided between the air guide base 251 and the piston casing 23, and the spacer plate 254 further limits a movement of the reversing brake block 253 from escaping the second section 260 of the air inlet duct 255. A first air hole 268 is formed in the spacer plate 254 for air entering the piston casing 23.

Referring back to FIG. 4, in addition to being formed with the piston working space 231, the piston casing 23 is further formed with a plurality of return ducts 234, a number of the return ducts 234 is the same as a number of the secondary working air ducts 257, an opening in one end of each of the return ducts 234 is communicated with the piston working space 231, and an opening in the other end of each of the return ducts 234 is indirectly communicated with one of the secondary working air ducts 257. Specifically, the spacer plate 254 is provided between the piston casing 23 and the air guide base 251, and the spacer plate 254 is further formed with a plurality of second air holes 270 in addition to the first air hole 268, and the second air holes 270 serve as bridges between the return ducts 234 and the secondary working air ducts 257.

Referring back to FIG. 3, FIG. 4, FIG. 5, and FIG. 6, in addition to the foregoing, the pneumatic saw 20 further includes an air exhaust design which exhausts air from one end of the housing 22 away from the saw blade 21. Specifically, the pneumatic saw 20 includes an air exhaust space 28 formed and defined by at least the housing 22, the piston casing 23, and the air guide base 251 together. The piston casing 23 is formed with a plurality of air exhaust holes 232 communicated with the piston working space 231, and air exhaust of the air exhaust holes 232 depends on a movement position of the piston 24. Referring to FIG. 6, the air guide base 251 is formed with an air leakage hole 271 communicated with the second section 260 of the air inlet duct 255. Further, the air leakage hole 271 is not shielded by the air blocking ring 252.

Operation of the pneumatic saw 20 is briefly described. Referring to FIG. 3, when high-pressure air enters the air inlet duct 255, the high-pressure air sequentially enters the primary working air ducts 256 and the vent groove 265 from the first section 259 of the air inlet duct 255, and finally enters the piston working space 231 through the first air hole 268 of the spacer plate 254 to push the piston 24 to move in a direction opposite to the air guide base 251. At the same time, the reversing brake block 253 abuts against the partition rib 258 due to a flow direction of the high-pressure air and shields the secondary working air ducts 257. Further, after movement of the piston 24, the high-pressure air will be exhausted into the air exhaust space 28 through the air exhaust holes 232 in the piston casing 23 and finally exhausted out of at least one end cap 29 at one end of the housing 22 opposite to the saw blade 21.

Further referring to FIG. 4, during movement of the piston 24 in the direction opposite to the air guide base 251, part of air in the piston working space 231 is forced to enter the return ducts 234 and flow towards the secondary working air ducts 257, and return air will push the reversing brake block 253 to move towards the piston casing 23 while being exhausted from the secondary working air ducts 257. And referring to FIG. 6, when the piston 24 is pushed to an end in the direction opposite to the air guide base 251, the return air will disappear because the piston 24 no longer compresses the space, and the high-pressure air that is continuously introduced enters the secondary working air ducts 257 and the return duct 234, and pushes the piston 24 back The foregoing operation is repeated thereafter to achieve reciprocal displacement of the piston 24 so as to reciprocally drive the saw blade 21.

In an embodiment, a plurality of transverse through holes 263 of the primary working air ducts 256 are located on an extension line, and two of the plurality of transverse through holes 264 of the secondary working air ducts 257 are located on an extension line. In the foregoing embodiment, the plurality of transverse through holes 264 located on the extension line may be formed by drilling at one time in a single drilling operation to simplify a manufacturing process of the air guide base 251. In addition to the foregoing, in an embodiment, two of the plurality of transverse through holes 264 of the secondary working air ducts 257 are provided side by side.

Referring back to FIG. 1 to FIG. 2, in an embodiment, the air guide base 251 includes a plurality of first connecting holes 272, and the piston casing 23 includes a plurality of second connecting holes 233 respectively connected to the first connecting holes 272. Each of the first connecting holes 272 is respectively provided for disposal of a connecting member 41 therein and is assembled with one of the second connecting holes 233, so that the air guide base 251 and the piston casing 23 constitute an assembly. Also, the connecting member 41 includes a cap portion 411. For example, the connecting member 41 may be a flat head bolt. On the other hand, each of the first connecting holes 272 is formed at a position where a vertical projection of the cap portion 411 of the connecting member 41 contacts with the air blocking ring 252, so that the cap portion 411 restrict a position of the air blocking ring 252 when the connecting member 41 connected to the air guide base 251 and the piston casing 23, namely a portion of the cap portion 411 is pressed against an end surface of the air blocking ring 252.

Referring back to FIG. 1, FIG. 2, FIG. 3, FIG. 4, FIG. 5, and FIG. 6, the pneumatic saw 20 further includes an air inlet assembly 30 matched with the air guide assembly 25. The air inlet assembly 30 includes an air inlet casing 301, an air valve 302, and an operating rod 303. The air inlet casing 301 is provided in the housing 22, and the air inlet casing 301 and the housing 22 are assembled in a threaded manner. Specifically, a first assembly thread 304 is formed on an outer surface of the air inlet casing 301, while a second assembly thread 305 matched with the first assembly thread 304 is formed on an inner wall of the housing 22. Through the foregoing results, the present invention solves the problem that a positioning manner adopted by a conventional air inlet casing may increase difficulties in repair. Furthermore, as observed from an external appearance of the air inlet casing 301, the air inlet casing 301 includes a double-cut plane 306 and two arc-shaped surfaces 307 respectively connected to two ends of the double-cut plane 306. After the air inlet casing 301 is mounted on the housing 22, the double-cut plane 306 does not contact with the housing 22 and forms a hollow, and the hollow constitutes a portion of the air exhaust space 28. The assembly of the air inlet casing 301 may be assisted by a jig of the same type.

Referring back to FIG. 3 FIG. 4, FIG. 5, FIG. 6, and FIG. 7, the air inlet casing 301 includes an air inlet passage 308 communicating with the air inlet duct 255 of the air guide base 251, a mounting manifold 309 communicating with the air inlet passage 308, and a rod mounting hole 310 provided for insertion of the operating rod 303. Further, the air valve 302 is provided at an intersection of the air inlet passage 308 and the mounting manifold 309. Furthermore, the air valve 302 is provided into the air inlet casing 301 from the mounting manifold 309 for determining whether the air inlet passage 308 is smooth. Further, an opening of the mounting manifold 309 is assembled with a closure 311 to close the mounting manifold 309 when mounting the air valve 302 is completed, and limit air entering the air inlet casing 301 to take the air inlet passage 308 as an unique flow path. In an embodiment, the closure 311 and the air inlet casing 301 are assembled in a threaded manner. Further, the operating rod 303 is matched with a pressing plate 42 provided outside the housing 22, and the operating rod 303 protrudes out of the housing 22 after being assembled with the air valve 302. The housing 22 includes a through hole 221 into which the operating rod 303 is inserted. The through hole 221 corresponds to the rod mounting hole 310 when the air inlet casing 301 is provided into the housing 22. Referring back to FIG. 7, an assembly of the operating rod 303 is described. The operating rod 303 is not assembled at the same time as the air inlet casing 301. During assembly, the air inlet casing 301 is firstly provided into the housing 22, and when the rod mounting hole 310 is aligned with the through hole 221, the operating rod 303 penetrates into the rod mounting hole 310 via the through hole 221 until the operating rod 303 is assembled with the air valve 302. At the same time, function of the operating rod 303 is not only to control the air valve 302, but also to limit a position of the air inlet casing 301.

Referring back to FIG. 4 to FIG. 5, in an embodiment, the pneumatic saw 20 further includes at least one noise reduction member 43, at least one noise reduction member limiting plate 44, and a spring 45. The at least one noise reduction member 43 may be cotton, and the noise reduction member 43 is provided in the air exhaust space 28. The at least one noise reduction member limiting plate 44 is provided on a side of the air inlet casing 301 facing the air guide base 251, and the at least one noise reduction member limiting plate 44 is provided for limiting the at least one noise reduction member 43 to be located at a periphery of the air guide base 251 only. The at least one noise reduction member limiting plate 44 includes at least one via hole 441 disposed corresponding to the at least one noise reduction member 43, and the via hole 441 is provided for air flowing in the air exhaust space 28 to pass through. Further, the spring 45 respectively abuts against the noise reduction member limiting plate 44 and the air guide base 251, and a force provided by the spring 45 to the noise reduction member limiting plate 44 drives the noise reduction member limiting plate 44 adhering to the air inlet casing 301 so as to limit a position of the at least one noise reduction member 43.

What is claimed is:

1. A pneumatic saw provided for a saw blade reciprocating upon activation, comprising:
a housing comprising a hollow shape;
a piston casing provided in the housing and forming a piston working space and a plurality of return ducts communicating with the piston working space;
a piston provided in the piston working space and provided for pushing the saw blade; and
an air guide assembly provided in the housing, the air guide assembly comprising a reversing brake block, an air guide base, a spacer plate provided on a side of the air guide base facing the piston casing, and an air blocking ring provided on the air guide base, the air guide base comprising an air inlet duct provided for disposal of the reversing brake block therein and communicating with the piston working space, a plurality of primary working air ducts communicating with the air inlet duct, and a plurality of secondary working air ducts communicating with the air inlet duct and the return ducts, each of the primary working air ducts and each of the secondary working air ducts respectively comprising a longitudinal hole parallel to the air inlet duct, and a transverse through hole communicating with the air inlet duct and the longitudinal hole, one end of the transverse through hole being shielded by the air blocking ring, the air blocking ring being fixed to the air guide base by a pin member, and the air guide base comprising a pin mounting hole for providing the pin member.

2. The pneumatic saw of claim 1, wherein the plurality of transverse through holes of the primary working air ducts are located on an extension line, and two of the plurality of transverse through holes of the secondary working air ducts are located on an extension line.

3. The pneumatic saw of claim 2, wherein two of the plurality of transverse through holes of the secondary working air ducts are provided side by side.

4. The pneumatic saw of claim 1, wherein the air guide base comprises a vent groove communicating with the primary working air ducts and the air inlet duct.

5. The pneumatic saw of claim 4, wherein the air guide base comprises an air leakage hole connected to the air inlet duct, and the air leakage hole is not shielded by the air blocking ring.

6. The pneumatic saw of claim 1, wherein the air guide base comprises a plurality of first connecting holes, the piston casing comprises a plurality of second connecting holes respectively connected to the first connecting holes, each of the first connecting holes is respectively provided for disposal of a connecting member therein, and the connecting member comprises a cap portion capable of limiting a position of the air blocking ring.

7. The pneumatic saw of claim 1, wherein the pneumatic saw comprises an air inlet assembly matched with the air guide assembly, the air inlet assembly comprises an air inlet casing provided in the housing, an air valve provided in the air inlet casing, and an operating rod provided on the air inlet casing and assembled with the air valve, the housing comprises a through hole through which the operating rod passes, the air inlet casing comprises an air inlet passage communicating with the air inlet duct of the air guide base, a mounting manifold communicating with the air inlet passage, and a rod mounting hole corresponding to the through hole and provided for insertion of the operating rod, the air valve is located at an intersection of the air inlet passage and the mounting manifold, an opening of the mounting manifold is assembled with a closure, and the air inlet casing and the housing are assembled in a threaded manner.

8. The pneumatic saw of claim 7, wherein the pneumatic saw comprises an air exhaust space formed between the air inlet casing and the housing, at least one noise reduction member provided in the air exhaust space, at least one noise reduction member limiting plate provided on a side of the air inlet casing facing the air guide base to limit the at least one noise reduction member to be located at a periphery of the air inlet casing, and a spring abuts against the noise reduction member limiting plate and the air guide base, and the noise reduction member limiting plate comprises at least one via hole corresponding to the at least one noise reduction member.
